SEQUENCE LISTING (5 sequences)

SEQ ID NO: 1 - DNA, 45 bp, synthetic construct
  misc_feature 1..45: note = Exemplary DNA Tracer
  source 1..45: mol_type = other DNA
cacctacagtccacagaacgtttttcctgtcacactctactccga

SEQ ID NO: 2 - DNA, 20 bp, synthetic construct
  misc_feature 1..20: note = Exemplary DNA Tracer Forward Primer
  source 1..20: mol_type = other DNA
cacctacagtccacagaacg

SEQ ID NO: 3 - DNA, 20 bp, synthetic construct
  misc_feature 1..20: note = Exemplary DNA Tracer Reverse Primer
  source 1..20: mol_type = other DNA
tcggagtagagtgtgacagg

SEQ ID NO: 4 - DNA, 20 bp, synthetic construct
  misc_feature 1..20: note = 5' binding segment of Forward primer for detection by LFT
  source 1..20: mol_type = other DNA
aaaaaaaaaaaaaaaaaaaa

SEQ ID NO: 5 - DNA, 20 bp, synthetic construct
  misc_feature 1..20: note = 5' binding segment of Reverse primer for detection by LFT
  source 1..20: mol_type = other DNA
cctgcgtctatgagtctact

(19) United States
(12) Patent Application Publication
(10) Pub. No.: US 2024/0384162 A1
(43) Pub. Date: Nov. 21, 2024

(54) SILICA-ENCAPSULATED TRACERS FOR USE IN FRACTURING FLUIDS AND METHODS OF PREPARATION AND ETCHING THEREOF

(71) Applicant: NCS MULTISTAGE INC., Calgary (CA)

(72) Inventors: Kha Quan TRAM, Burlington, Ontario (CA); Hongbin YAN, St. Catharines, Ontario (CA); Frank MONTOYA BETANCOURT, St. Catharines, Ontario (CA)

(21) Appl. No.: 18/714,154

(22) PCT Filed: Nov. 30, 2022
(86) PCT No.: PCT/CA2022/051752

§ 371 Date: May 29, 2024

Related U.S. Application Data
(60) Provisional application No. 63/264,748, filed on Dec. 1, 2021.

(51) Int. Cl. C09K 8/90; C09K 13/00; E21B 47/11; E21B 49/08

(52) U.S. Cl. CPC C09K 8/905; C09K 13/00; E21B 47/11; E21B 49/08; C09K 2208/10

(57) ABSTRACT

Silica-encapsulated tracers suitable for use in tracing fracturing fluid in subsurface formations are described herein. More specifically. described herein is an improved method of encapsulating tracers for reduced adsorption on a rock material, as well as less caustic methods for releasing the encapsulated tracers using ammonium hydroxide or other weak base as an etching agent. as an alternative to using highly corrosive reagents such as hydrofluoric acid.

### FIELD

The present description relates to silica-encapsulated tracers for use in fracturing fluids and other downhole applications. Specifically, the present description relates to less caustic methods of etching a silica shell to release encapsulate material. The present description also relates to improved methods of encapsulating tracers and other materials for reduced adsorption on subsurface rock material.

### BACKGROUND

Hydraulic fracturing is a known method for injecting a fluid (e.g., water, often mixed with proppants [e.g., sand] and thickening agents) at high pressures into an oil or gas well to create small fractures or expand existing fractures in the subsurface formation, thereby allowing the oil or gas to flow more freely and facilitate its recovery. To monitor the flow or disposition of the fracturing liquid, or whether the hydraulic fracturing process is effective, tracing the fracturing fluid is commonly used. This technique involves adding unique tracers to the hydraulic fracturing fluid before injection into the well, recovering the fracturing fluid, and identifying the tracer from a sample of the fluid. The use of labile tracers has been proposed, wherein the tracers are encapsulated for example in a silica shell. However, release of the tracers from the silica shell typically necessitates the use of highly caustic etching agents such as hydrofluoric acid. Thus, improved methods for encapsulating and releasing encapsulated tracers would be highly desirable.

### SUMMARY

In a first aspect, described herein is a method for releasing an encapsulate material encapsulated in a silica outer shell. The method generally comprises contacting the silica outer shell with an etching solution comprising ammonium hydroxide or other weak base as an etching agent at a sufficient concentration and for a sufficient time to enable release of the encapsulate material into solution or to allow solvent-access to the encapsulate material. The released encapsulate material may then be isolated and/or detected. In some implementations, the encapsulate material may be a tracer, for example for use in fracturing fluids and other downhole applications. In some implementations, the tracer may be complexed with a nanoparticle to form a tracer-nanoparticle core, which is encapsulated in the silica outer shell.

In a further aspect, described herein is a method of tracing fluids in subsurface formations (e.g., fracturing fluids in oil-or gas-containing subsurface formations). The method generally comprises providing a plurality of unique encapsulated tracers, each tracer encapsulated in a silica outer shell; pumping a plurality of fracturing fluid volumes into the subsurface formation, each volume comprising a unique encapsulated tracer, thereby defining a plurality of fracture zones: pumping fluids out of the formation while taking well fluid samples: collecting the unique encapsulated tracers from each well fluid sample and releasing the unique encapsulated tracers by contacting the silica outer shell with an etching solution comprising ammonium hydroxide or other weak base as an etching agent at a sufficient concentration and for a sufficient time to enable release of the tracer into solution: and identifying and/or detecting the unique tracer within each well fluid sample.

In a further aspect, described herein is a method of encapsulating a tracer prone to adsorption on a rock material. The method generally comprises: providing a silica nanoparticle (SNP) that is functionalized to facilitate complexing to the tracer prone to adsorption on the rock material: complexing the tracer to the silica nanoparticle in the presence of a buffer that facilitates tracer loading or deposition on the SNP to form a tracer-nanoparticle core: and encapsulating the tracer-nanoparticle core in a silica shell by treating the tracer-nanoparticle core particles with a silica shell-forming solution in the presence of a low concentration of ammonium hydroxide for a sufficient time to fully encapsulate the tracer-nanoparticle core.

In a further aspect, described herein are encapsulated tracers produced by the above encapsulation method, which are suitable for use in tracing fracturing fluid in oil-or gas-containing subsurface formations.

In a further aspect, described herein is a method of tracing a fluid recovered from a subsurface reservoir, the method comprising: providing the encapsulated tracer as defined above/herein comprising an outer shell and a tracer compound, in a formation to mix with a reservoir fluid: recovering a portion of the reservoir fluid to surface, the reservoir fluid comprising the encapsulated tracer: and detecting the tracer compound in the sample.

### General Definitions

Headings, and other identifiers, e.g., (a), (b), (i), (ii), etc., are presented merely for ease of reading the specification and claims. The use of headings or other identifiers in the specification or claims does not necessarily require the steps or elements be performed in alphabetical or numerical order or the order in which they are presented.

The use of the word “a” or “an” when used in conjunction with the term “comprising” in the claims and/or the specification may mean “one” but it is also consistent with the meaning of “one or more”, “at least one”, and “one or more than one”.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “about” is used to indicate that a value includes the standard deviation of error for the device or method being employed in order to determine the value. In general, the terminology “about” is meant to designate a possible variation of up to 10%. Therefore, a variation of 1, 2, 3, 4, 5, 6, 7, 8, 9 and 10% of a value is included in the term “about”. Unless indicated otherwise, use of the term “about” before a range applies to both ends of the range.

Other objects, advantages and features of the present description will become more apparent upon reading of the following non-restrictive description of specific implementations thereof, given by way of example only with reference to the accompanying drawings.

### BRIEF DESCRIPTION OF THE DRAWINGS

In the appended drawings:

FIG. 1A-1C show schematic diagrams of the nanoparticle assembly including a silica nanoparticle functionalized to have a positively charged surface (SNP⁺: FIG. 1A), an anionic tracer complexed to the SNP⁺ to form a, SNP-Tracer core (FIG. 1B), and a silica outer shell encapsulating the SNP-Tracer core (SNP²-Tracer: FIG. 1C).

FIG. 2 is a sodium dodecyl sulphate-polyacrylamide gel electrophoresis (SDS-PAGE) gel showing the optimization of the PCR amplification of the released DNA tracer with different annealing temperatures.

FIG. 3 is an SDS-PAGE gel showing the optimization of the PCR amplification of the released tracer DNA with different PCR amplification cycle numbers.

FIG. 4 shows the amount of adsorption of the Fluorescein-DNA tracers following flow-through in a column of three different types of packed rock material: Heebner shale, Woodford shale, and Woodford shale (cleaned). Naked Fluorescein-DNA exhibited near complete adsorption on the rock material, in contrast to encapsulated Fluorescein-DNA [SNP²-(Fluorescein-DNA)], which was capable of migrating through the column. The positive control (“+”) was 0.625 μM of naked Fluorescein-DNA (FAM-DNA) in water.

FIG. 5 shows an example of a lateral flow test (LFT) that was used to detect released tracer DNA without an amplification step. SNP2-DNA was passed through a rock-column, recovered, etched and diluted 10-, 1000-, or 10,000-fold with PBS prior to direct testing using an LFT adapted to detect the presence of a segment of the tracer DNA sequence. A signal at the test line was observed in the 10-and 1000-fold dilutions, but not in the negative control (“−”) or 10,000-fold diluted samples. A signal at the control line was present in all tests, indicating a fully functional test.

FIG. 6 shows an example of an LFT that was used to detect released tracer DNA following a PCR amplification step at three different amplification conditions (A, B, and C). A signal at the test line was observed for all three PCR amplification conditions but not in the negative control (“(−)”). A signal at the control line was present in all tests, indicating a fully functional test.

### SEQUENCE LISTING

This application contains a Sequence Listing in computer readable form created Nov. 30,2022. The computer readable form is incorporated herein by reference.

TABLE 1
Sequence Listing Description

| SEQ ID NO: | Description |
|---|---|
| 1 | Exemplary tracer DNA |
| 2 | Exemplary Forward Primer for PCR amplification |
| | of tracer DNA |
| 3 | Exemplary Reverse Primer for PCR amplification |
| | of tracer DNA |
| 4 | LFT binding segment of Forward primer in Table 4 |
| 5 | LFT binding segment of Reverse primer in Table 4 |

### DETAILED DESCRIPTION

In a first aspect, described herein is a less caustic method of etching silica shell nanoparticles to release their encapsulate material. As used herein, the term “etching” refers to disrupting a silica outer shell to enable sufficient release of the encapsulate material into solution and/or enable solvent-access of the encapsulate. Conventional silica shell nanoparticle removal is performed using acids such as hydrofluoric acid (HF) that dissolve the silica, which is highly corrosive and is considered a powerful contact poison. In some implementations, described herein is a method for releasing an encapsulate material encapsulated in a silica outer shell using an etching solution comprising ammonium hydroxide or other weak base as an etching agent at a sufficient concentration and for a sufficient time to enable release of the encapsulate material into solution. In some implementations, a weak base other than ammonium hydroxide maybe used, wherein the weak base is preferably an organic weak base, a biodegradable weak base, a volatile weak base, or any combination thereof.

The use of ammonium hydroxide or other weak base herein provides at least two main benefits over the commonly used HF. First, ammonium hydroxide is easier to use than HF. From an operational perspective, shipping, handling, regulations that surround the use of ammonium hydroxide in the environment is more streamlined. Second, ammonium hydroxide may be considered “traceless” since ammonia will actively evaporate from the solution, thereby leaving no trace and minimizing complications during downstream detection steps. For example, for detection steps that involve enzymatic reactions (e.g., PCR amplification), the presence of remaining counter ions (c.g., fluoride or other anions) may inhibit activity and/or reduce specificity of the enzyme, thereby requiring an additional purification step to remove the counter ions. The use of a volatile reagent, such as ammonium hydroxide, is thus beneficial in such implementations.

In some implementations, the encapsulate material is released from its silica outer shell with an etching solution comprising ammonium hydroxide or other weak base as an etching agent for at least 3,3.5, 4, 4.5, 5, 5.5, 6, 7, 8, 9, 10, 11, 12, 24, 36, 48, 60, or 72 hours. In some implementations, the encapsulate material is released from its silica outer shell by incubation at a temperature of at least 45, 50,55, 60, 65, or 70° C. In some implementations, the concentration of ammonium hydroxide or other weak base in the etching solution may be from 3 to 10 M, or any concentration therebetween. In some implementations, the pH of the etching solution may be at least 10, 10.5, 11, or 11.5. In preferred implementations, the encapsulate material is released without the use of hydrofluoric acid or other highly corrosive acids as an etching agent. In other preferred implementations, the encapsulate material is released without the use of a highly corrosive and/or strong base as an etching agent. In some implementations, the avoidance of highly corrosive acids and bases to release encapsulated materials may be particularly advantageous for encapsulates that would be damaged by such reagents.

In some implementations, the encapsulate material may be a detectable marker material or tracer, suitable for use in tracing fracturing fluid in subsurface formations (c.g., oil-or gas-containing subsurface formations). In some implementations, the encapsulate material may be or may comprise a material that is: anionic, cationic, zwitterionic, or charge-neutral. In some implementations, the encapsulate material may be or may comprise an anionic tracer, a cationic tracer, a zwitterionic tracer, a charge-neutral tracer, a biological tracer (e.g., peptide, protein, lipid, nucleic acid, or polysaccharide), a polynucleotide tracer (e.g., DNA, RNA. polynucleotide analog), a chemical tracer (e.g., a halogenated benzoic ester), a radioactive tracer, a dye tracer, a polymeric tracer, or any combination thereof. In some implementations, the polynucleotide analog may be a mixture of DNA or RNA and one or more synthetic nucleotide analogs, preferably rendering the polynucleotide analog more stable than its native polynucleotide counterpart. In some implementations, the polynucleotide analog is preferably capable of participating in

Watson-Crick base pairing. In some implementations, the polynucleotide analog may be a peptide nucleic acid (PNA) or phosphorodiamidate morpholino oligomer (PMO).

In some implementations, the encapsulate material may comprise more than one type of marker material or tracer, such as a polynucleotide or polynucleotide analog tracer and a chemical tracer, a radioactive tracer, and/or a dye tracer. The inclusion of a tracer visible to the naked eye and/or that is rapidly identifiable using a rapid point-of-use test may be particularly advantageous. In some implementations, the use of polynucleotide or polynucleotide analog tracers is advantageous because of its near limitless possibilities in terms of generating unique tracers (due to variations in base sequences), as well as the plurality of highly sensitive and specific techniques available for their detection. In some implementations, when the tracer is a polynucleotide or polynucleotide analog capable of Watson-Crick base pairing, the tracer may be detected by a method comprising amplification (e.g., PCR), hybridization, sequencing, CRISPR-based detection, or any combination thereof.

In some implementations, it maybe advantageous to complex the encapsulate material to a nanoparticle to form an encapsulate material-nanoparticle core, prior to encapsulation in a silica outer shell. In some implementations, different types of nanoparticles may be envisaged, including a nanoparticle that comprises or consists of a silica nanoparticle (SNP), a magnetic nanoparticle, a gold nanoparticle, a silver nanoparticle, a metal-oxide (e.g., iron-oxide) nanoparticle, a carbon-based nanoparticle, a ceramic nanoparticle, a metal nanoparticle, semiconductor nanoparticles, a polymeric nanoparticle, a lipid-based nanoparticle, or any combination thereof. In some implementations, the core encapsulated in the silica outer shell may comprise a tracer embedded in a porous carrier material, such as diatomaceous earth, ceramic, expanded clay, silica gel, acroclay, aerogel, or expanded glass. In some implementations, the nanoparticle, or the encapsulate material-nanoparticle core encapsulated in the silica outer shell, may have an average minimum diameter of at least 1, 25, 50, 75, 100, 125, 150, 175, 200,250, 300, 350, 400, 450, or 500 nm, and/or an average maximum diameter of 100, 125, 150, 175, 200,250, 300, 350, 400, 450, 500, 550, 600, 650, 700, 750, 800, 850 950, 1000, 2000, 2500, 3000, 4000, 5000,6000, 7000, 8000, 9000, or 10,000 nm. Without being bound by theory, larger particle sizes (˜ higher micron range) may experience greater difficulty migrating throughout subsurface formations, while smaller particles (˜nanometer range) may behave more fluid-like and migrate more easily through the underground medium. Conversely, larger particles may provide the benefit of a higher surface area, being casier to isolate (e.g., via centrifugation at lower speeds) and the potential of encapsulating greater amounts of tracer.

In some implementations, the encapsulate material may be relcasably or non-releasably complexed to the nanoparticle. In some implementations, the encapsulate material may be ionically or covalently complexed to the nanoparticle, or may be complexed to the nanoparticle via physisorption. In some implementations, the encapsulate material may be covalently complexed in a cleavable or non-cleavable manner to the nanoparticle.

In a further aspect, described herein is a method for recovering encapsulate material (c.g., a tracer) encapsulated in a silica outer shell. In some implementations, the method comprises: (a) contacting the silica outer shell with an etching solution comprising ammonium hydroxide or other weak base as an etching agent at a sufficient concentration and for a sufficient time to enable release of the encapsulate material into solution: and (b) optionally isolating and/or detecting the released encapsulate material. In some implementations, the silica outer shell may be contacted with the etching solution: for at least 3, 3.5,4. 4.5, 5, 6, 7, 8, 9, 10, 11, 12, 24, 36, 48, 60, or 72 hours; and/or at a temperature of at least 45, 50, 55,60, 65, or 70° C. In some implementations, the other weak base and/or the encapsulate material or tracer is as defined herein. In some implementations, the etching of the silica outer shell may be carried out without the use of hydrofluoric acid or other highly corrosive acids, or without the use of a highly corrosive and/or strong base as an etching agent. In some implementations, the released encapsulate material may be isolated via any suitable method, such as filtration (e.g., membrane and/or porous filters), centrifugation, use of a column, or any combination thereof. In some implementations, encapsulate material may be detected via a lateral flow or other suitable rapid point-of-use test, either directly or following a further processing step (c.g., amplification in the case of tracer DNA).

In a further aspect, described herein is a method of tracing fracturing fluid (e.g., in oil- or gas-containing subsurface formations). In some implementations, the method comprises: (a) providing a plurality of unique encapsulated tracers, each tracer encapsulated in a silica outer shell: (b) pumping a plurality of fracturing fluid volumes into the subsurface formation, cach volume comprising a unique encapsulated tracer, thereby defining a plurality of fracture zones: (c) pumping fluids out of the formation while taking well fluid samples: (d) collecting the unique encapsulated tracers from each well fluid sample and releasing the unique encapsulated tracers by contacting the silica outer shell with an etching solution comprising ammonium hydroxide or other weak base as an etching agent at a sufficient concentration and for a sufficient time to enable release of the tracer into solution: and (c) optionally identifying and/or detecting the unique tracer within each well fluid sample. In various implementations, the tracer, the other weak base, and/or the etching step may be as defined herein. In some implementations, the subsurface formations may comprise predominantly anionic rock material (c.g., shale or sandstone).

While it has been previously reported that adsorption of anionic compounds is low or even negligible on anionic rock material, such as shale or sandstone (Muherei et al., 2009; Chee et al., 2021), the results in Example 5 show that free (unencapsulated) polyanionic DNA are prone to nearly complete adsorption on shale rock, but that adsorption may be greatly reduced by encapsulation in a silica outer shell. In a further aspect, described herein is a method of encapsulating a tracer prone to adsorption on a rock material (e.g., shale or sandstone). The method may comprise: (a) providing a silica nanoparticle (SNP) that is functionalized to facilitate complexing to the tracer prone to adsorption on the rock material: (b) complexing the tracer to the silica nanoparticle in the presence of a buffer that facilitates tracer loading or deposition on the SNP to form a tracer-nanoparticle core: and (c) encapsulating the tracer-nanoparticle core in a silica shell by treating the tracer-nanoparticle core particles with a silica shell-forming solution in the presence of a low concentration of ammonium hydroxide for a sufficient time to fully encapsulate the tracer-nanoparticle core. In some implementations, the silica shell-forming solution may comprise trimethyl [3-(trimethoxysilyl) propyl] ammonium chloride (TMAPS) and tetraethoxysilane (TEOS), or other suitable silica sources. In some implementations, the low concentration of ammonium hydroxide may be 0.01 to 0.2 M, 0.015 to 0.15 M, 0.02 to 0.1 M, 0.025 to 0.075 M: or being at about 0.01, 0.02, 0.03, 0.04, 0.05, 0.06, 0.07, 0.08, 0.09, 0.1, 0.125, 0.15, or 0.175 M. In some implementations, the tracer-nanoparticle core in (c) may be treated with the silica shell-forming solution for at least 12, 24,36, 48, 72, or 96 hours. In some implementations, the SNP may be functionalized to be cationic, the tracer may be an anionic tracer, and the loading or deposition in (b) may be advantageously performed in the presence of an alkaline buffer (c.g., at a pH of about 7.2, 7.3, 7.4, 7.5, 7.6, 7.7, 7.8, 7.9, 8.0, 8.1, 8.2, 8.3,8.4, 8.5, 8.6, 8.7, 8.8, 8.9, or 9; or between 7.2 and 9). In some implementations, a Tris or Tris-HCI buffer may be used. In some implementations, the Tris or Tris-HCI buffer may be at a concentration of at least 1,5, 10, 20, 30, 40, 50, 100, 200, 300, 400, or 500 mM. The Tris buffer may also have any pH between 6and 8, or have a pH of about 7.8. In some implementations, the tracer or the tracer-nanoparticle core may be as defined herein.

In a further aspect, described herein is an encapsulated tracer produced by a method as described herein, suitable for use in tracing fracturing fluid in oil-or gas-containing subsurface formations (e.g., characterized by predominantly anionic rock material, such as shale or sandstone). The encapsulated tracers can also be used in other applications, such as tracing in geothermal formations. The encapsulated tracers can be deployed by injection via a well or by incorporation into a downhole tool for release downhole.

The encapsulated tracer can be used in association with various tracing methods, some of which are described in U.S. Pat. Nos. 9,594,070, 10,017,684, 10,428,613, and PCT/CA2020/050540, which are incorporated herein by reference.

### EXAMPLES

### Example 1: Functionalization of Silica Nanoparticles

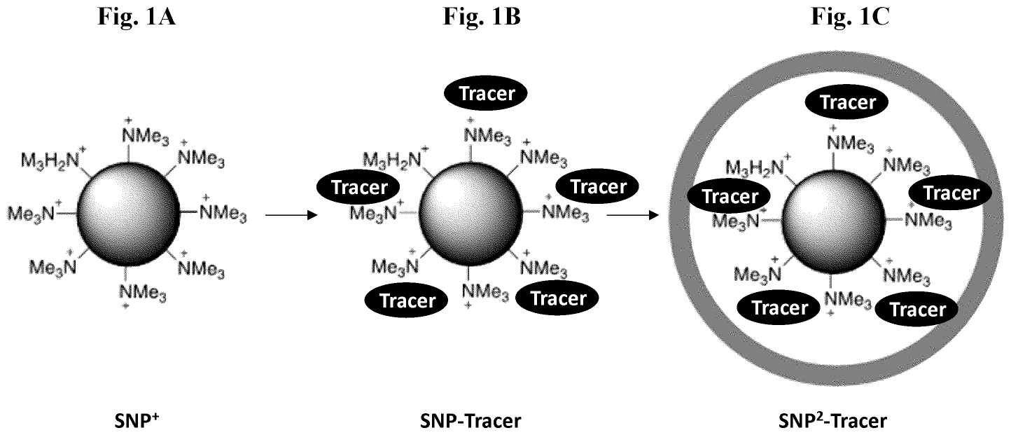

Silica nanoparticles (SNPs) (50 nm radius, 500 μL, 10 wt %) were centrifuged (15,000 rpm, 4 min) and the pellet was washed with absolute ethanol (3×1 mL). To produce SNPs with a positively charged surface (SNP⁺) (FIG. 1A), the pellets were then sonicated in absolute ethanol (670 μL) followed by the addition of water (50 μL), trimethyl [3-(trimethoxysilyl) propyl] ammonium chloride (TMAPS, 30 μL, 50% solution in methanol, 0.11 mmol) and 2 M ammonia in ethanol solution (250 μL). After the mixture was incubated for 6-24 hours on a wrist shaker (room temperature, max speed), isopropanol (1 mL) was added and the mixture was centrifuged (15,000 rpm, 4 min). The pellets were then washed with isopropanol (2×1 mL) and resuspended in isopropanol (1 mL). Functionalization was evaluated by measuring the amount binding of the anionic azo dye Reactive Green 19 (RG19) to the of SNP⁺. In this regard, while some RG19dye binding was observed after a 6-hour incubation, more robust RG19 dye binding was observed after a 19 to 24-hour incubation, suggesting that this incubation time achieved complete functionalization of the SNPs.

### Example 2: Preparation of SNP-Tracer Core Particles

SNP⁺ samples were centrifuged (15,000 rpm, 4 min) and the pellet was re-suspended in 900 μL of water. To the 1-mL SNP⁺ suspensions. 100 μL of a Tracer-containing solution [e.g., 100 μM Tracer DNA (SEQ ID NO: 1) or RG19] was added and the sample was incubated on a wrist shaker for 10 min (max speed). In some experiments, a Tracer DNA conjugated at its 5′ end to a fluorophore (fluorescein) was used to facilitate tracking of the Tracer DNA, which did not affect deposition on SNP⁺. Deposition of DNA or RG19 Tracer on the SNP' was carried out in either water or 10 mM Tris-HCI buffer (pH 7.8). Complexes were allowed to form between the negatively-charged DNA or RG-19 Tracer and the positively-charged SNP via ionic/electrostatic interaction to form SNP-Tracer core particles (FIG. 1B). After centrifugation (15,000 rpm, 4 min), the supernatant was collected and the core particle pellet was washed 3 times with water (1 mL). Each time, the supernatant was collected for the measurement of UV-Vis absorbance to monitor DNA deposition/release. Interestingly, loading/deposition of RG19 or DNA on the SNP⁺ carried out in 10 mM Tris-HCI buffer (pH 7.8) resulted in an 8-fold higher tracer recovery as compared to loading/deposition carried out in water.

### Example 3: Encapsulation of SNP-Tracer Core Particles in a Silica Outer Shell

Samples containing the SNP-Tracer core particles (FIG. 1B) were centrifuged (15,000 rpm, 4 min), the supernatant was discarded and resuspended in water (738 μL). To encapsulate the SNP-Tracer core particles in a silica outer shell, samples were treated with a silica shell-forming solution containing tetracthoxysilane (TEOS, 40 μL, 0.18 mmol) and TMAPS (40 μL, 50% solution in methanol, 0.014 mmol) in the presence of a relatively low concentration of ammonium hydroxide (8.5 μL of 1.76 M aqueous ammonium hydroxide, corresponding to a final concentration of ammonium hydroxide of 0.05 M) and was left shaking on a wrist shaker for 4 days (max speed). After the 4-day incubation, samples were centrifuged (15,000 rpm, 4 min) and washed 3 times with water (1 mL). The final pellet consisting of SNP-RG19 or SNP-DNA encapsulated in a silica outer shell (SNP²-Tracer: FIG. 1C) was reconstituted in 1 mL of water. Interestingly, a corresponding encapsulation reaction performed in the absence of ammonium hydroxide resulted in inadequate encapsulation that failed to protect the tracers from exposure to HCl (data not shown). Likewise, a corresponding encapsulation reaction performed at a higher concentration of ammonium hydroxide (0.2 M) produced SNP sizes that were too large and also failed to protect the tracers from exposure to HCI (data not shown). The use of higher concentrations of ammonium hydroxide with shorter incubation times resulted in less homogeneous SNP²-Tracer preparations, concomitant with the appearance of smaller silica particles lacking tracer.

### Example 4: Etching of Silica Outer Shell to Release and Detect DNA Tracers

To release DNA tracers from SNP²-DNA nanoparticles, concentrated ammonium hydroxide was explored as an etching agent as an alternative to the conventionally used highly corrosive acids (e.g., hydrofluoric acid), or other reagents used to break down silica that introduce counter ions that may negatively impact downstream DNA amplification. Successful release of DNA was evaluated post-etching by centrifuging samples (15,000 rpm, 4 min), lyophilizing the supernatant, and reconstituting in Milli-QTM water (100 μL) for PCR detection. For amplification of the DNA tracer, PCR and subsequent SDS-PAGE were carried out using the materials and parameters described in the Table 2.

TABLE 2
PCR and SDS-PAGE conditions

| PCR Reaction | PCR Program | SDS-PAGE |
|---|---|---|
| 10x Taq Buffer | 94° C. 3 min | 6.0 mL 40% acrylamide |
| 1 μL dNTP Stock (10 mM) | 94° C. 30 sec | 2% bis solution |
| 1 μL Forward Primer | 52° C. 15 sec | 1.2 mL of 10x TBE buffer |
| (50 μM) sequence: | 72° C. 60 sec | 4.74 mL of autoclaved |
| 5′-CACCTACAGTCCACAGAACG-3′ | 72° C. 7 min | Milli-Q water |
| (SEQ ID NO: 2) | | 60 μL of 10% APS w/v |
| 1 μL Reverse Primer | | 6 μL of TEMED |
| (50 μM) sequence: | | |
| 5′-TCGGAGTAGAGTGTGACAGG-3′ | | |
| (SEQ ID NO: 3) | | |
| 2 μL Template DNA tracer | | |
| sequence (positive control): | | |
| 5′-CACCTACAGTCCACAGAACGTT | | |
| TTTCCTGTCACACTCTACTCCGA-3′ | | |
| (SEQ ID NO: 1) | | |
| 39.5 μL Milli-Q H₂O | | |
| 0.5 μL Taq Polymerase | | |
| (0.5 units/μL) | | |

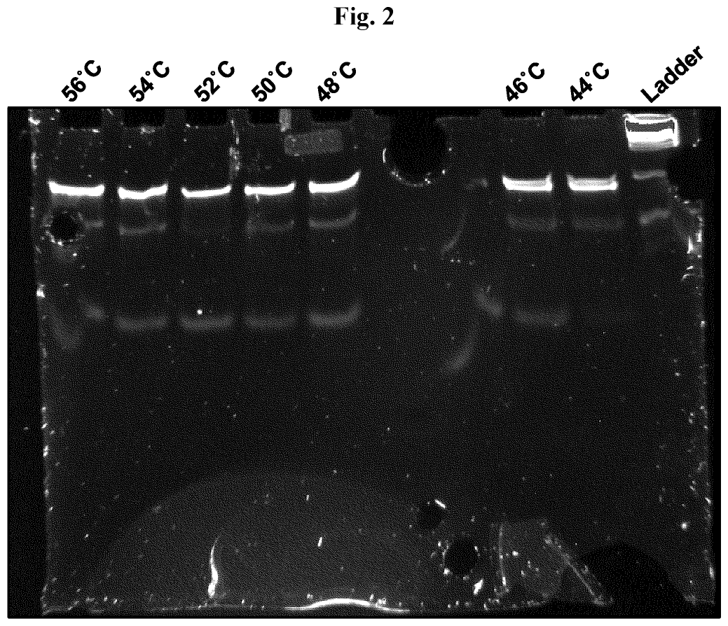

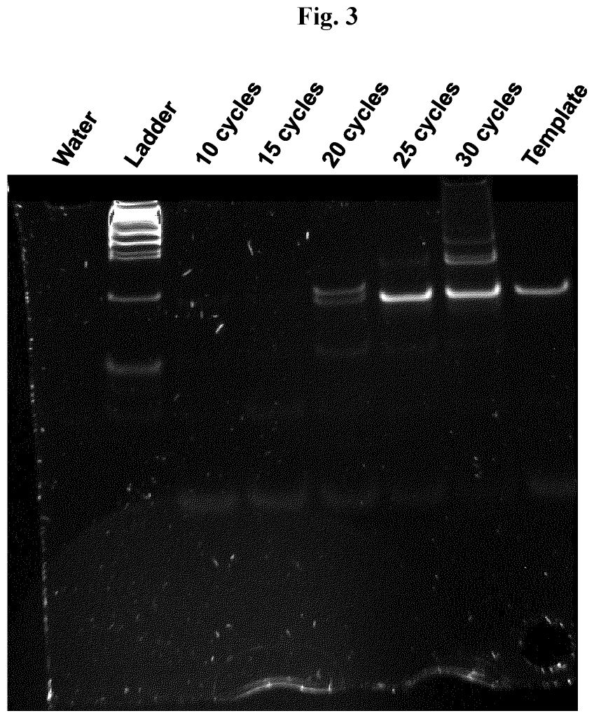

For the SDS-PAGE gel, a total of 10 μL of 50 bp MiniSizer™ DNA ladder (BioRad) was used and 2 μL of 6X orange loading dye was used per 10 μL of PCR product. The gel was run at 100 V for two hours and then stained in 50 mL of 1X TBE containing (5 μL of SYBRTM Safe DNA stain, 10,000X DMSO) for 30 min on a rocker. For the PCR reaction, the annealing step was carried out at various temperatures, with 52° C. showing the best result (FIG. 2). Furthermore, PCR amplification was carried out at 10, 15, 20, 25 and 30 cycles, with 25 cycles in Tris giving the best results (FIG. 3).

Interestingly, robust release and detection of DNA was observed by taking 100 μL of the SNP2-DNA solution diluted to 500 L with water, adding concentrated (14.8 M) ammonium hydroxide (200 to 900 uL, resulting in a concentration of ammonium hydroxide in the etching solution of about 3-10 M), and then incubating the samples at 60-65° C. for 3 hours to up to 3 days. While released DNA was detectable by PCR when etching was performed at 50° C., temperatures of 60-65° C. yielded optimal results and completely etched the silica outer shell. Meanwhile, rupture of the reaction vessel precluded any conclusions as to DNA release when etching was performed at high temperatures and high concentrations of ammonium hydroxide, which caused increased build-up/release of ammonia gas and reduced the effective concentration of ammonium hydroxide in the etching solution. A summary of the different etching parameters attempted, and their results is shown in Table 3.

TABLE 3
Parameters attempted for etching of SNP²-Tracer

| Etching parameters | Result* |
|---|---|
| 50° C., +200 μL conc. NH₄OH, 6 h | Partially etched the SNPs |
| 60-65° C., +200 μL conc. NH₄OH, 3-6 h | Completely etched the SNPs |
| 75° C., +900 μL conc. NH₄OH | (Reaction vessel ruptured) |
| 75° C., +200 μL conc. NH₄OH, 2 h | No etching detected |
| 85° C., +200 μL conc. NH₄OH, 2 h | No etching detected |
| 100 °C., +200 μL conc. NH₄OH, 2 h | (Reaction vessel ruptured) |
| 90° C., +200 μL conc. NH₄OH, 3 h, 4 h, | No etching detected |
| or 5 h | |
| 90° C., +500 μL conc. NH₄OH, 4 h | (Reaction vessel ruptured) |
| 90° C., 300 or 400 μL conc. NH₄OH, 4 h | No etching detected |
| 40° C., 300, 400, 500, 600, or 700 μL | No etching detected |
| conc. NH₄OH | |

*Degree of etching was evaluated by observing structural changes (e.g., particle size) in the etched SNP²-DNA particles by Dynamic Light Scattering (DLS).

As shown above, using ammonium hydroxide as an etching agent, insufficient etching and release of DNA was observed at temperatures below 50° C. and at incubation times of less than about 3 hours. However, the results in Table 3 reveal that etching parameters such as temperature, incubation time, and concentration of ammonia hydroxide, may be adapted to achieve the desired level of etching and/or tracer release.

### Example 5: Reduced Adsorption of Encapsulated Tracer DNA as Compared to Naked Tracer DNA

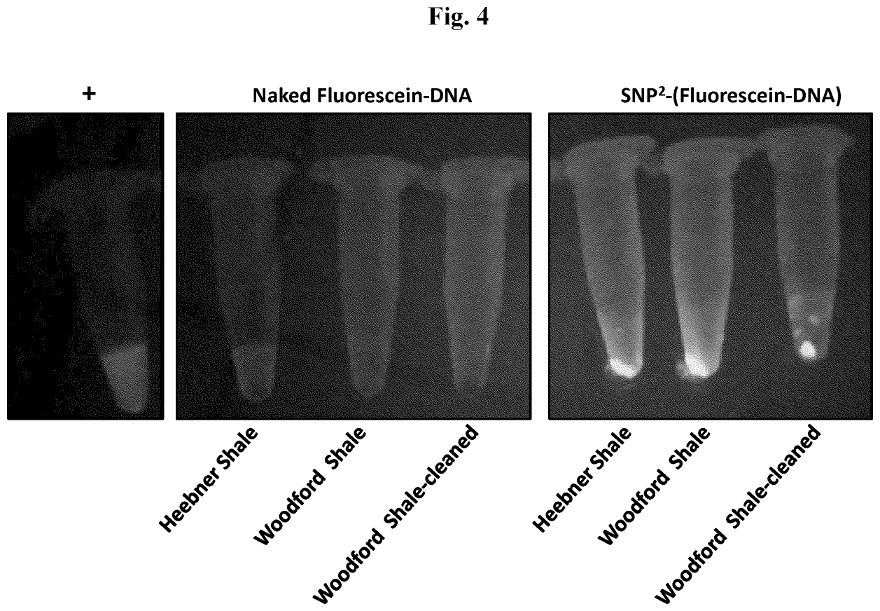

To test the effect of the silica outer shell on the adsorption of DNA to the rock material, columns were packed with rock material in a 10 mL glass pipette. Three different rock types were tested: Heebner shale. Woodford shale. and Woodford shale (cleaned). The column was first pre-washed with 5 mL of water and then a 100-μL sample of SNP²-(Fluorescein-DNA) was added to each column followed by rinsing with 5 mL of water. The flow-through was collected and centrifuged (21.000 RCF 10 min). FIG. 4 shows that naked Fluorescein-DNA exhibited near complete adsorption on the rock material. in contrast to encapsulated Fluorescein-DNA [SNP2-(Fluorescein-DNA)]. which was capable of migrating through the column. The positive control (“+”) in FIG. 4 was 0.625 uM of naked Fluorescein-DNA (FAM-DNA) in water.

### Example 6: Detection of Released Tracer DNA From Flow Through of Rock Samples by Lateral Flow Strip Tests

To the pellets in Example 5 was added 300 uL of concentrated aqueous ammonium hydroxide and the mixture was incubated in a screw-cap vial at 60° C. for 6 hours. After incubation. sample vials were left open at 75° C. for 30 minutes to evaporate the remaining ammonium hydroxide. The products were centrifuged (21.000 RCF 10 min) and the supernatant was collected and diluted with PBS 10x buffer (200μL). Lateral flow strip tests were used to test for the presence of tracer DNA.

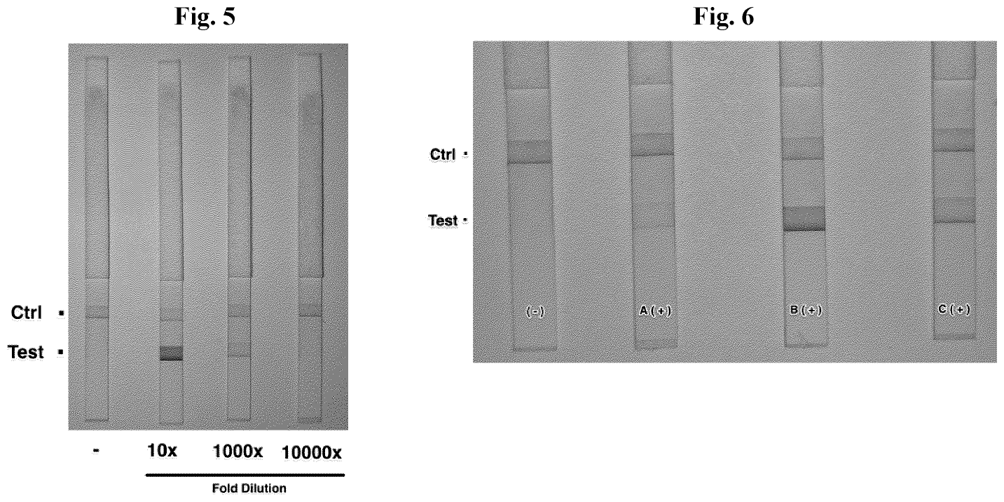

FIG. 5 shows an example of a lateral flow test (dip-stick) that was used to detect released tracer DNA without an amplification step. Briefly. encapsulated SNP²-DNA (SEQ ID NO: 1) was passed through a rock-column, recovered. and etched as described above. The released tracer DNA was diluted 10-, 1000-, or 10.000-fold with PBS and the solution was directly tested using the lateral flow test for the presence of tracer DNA sequences. Since the concentration of silica particles readily passed through the column. high amounts of tracer DNA were recovered and released after etching, which resulted in a strong signal at the test line in the 10-fold dilution (FIG. 5). Tracer DNA detection was concentration-dependent. as a weaker signal at the test line was observed in the 1000-fold dilution and no signal was detected following a 10,000-fold dilution (FIG. 5). The control line was present in all tests. indicating a fully functional test (FIG. 5).

FIG. 6 shows an example of a lateral flow test that was used to detect released tracer DNA following a PCR amplification step. Briefly. encapsulated SNP²-DNA (SEQ ID NO: 1) was passed through a rock-column. recovered. and etched as described above. The tracer DNA was then diluted in PBS, and a sample of the diluted tracer DNA was used for a PCR amplification reaction using the following modified primers:

TABLE 4
Modified PCR primers of binding to
lateral flow test

| | |
|---|---|
| Forward | 5′-AAAAAAAAAAAAAAAAAAAA-PEG linker- |
| Primer: | CACCTACAGTCCACAGAACG-3′[SEQ ID NO: 4]- |
| | PEG Spacer-[SEQ ID NO: 2] |
| Reverse | 5′-CCTGCGTCTATGAGTCTACT-PEG linker- |
| Primer: | TCGGAGTAGAGTGTGACAGG-3′[SEQ ID NO: 5]- |
| | PEG Spacer-[SEQ ID NO: 3] |

The Forward and Reverse PCR primers in Table 2 were modified to introduce binding segments (SEQ ID NOs: 4 and 5) that would be captured by the lateral flow reagents. The binding segments were covalently conjugated to the Forward and Reverse primers via a polyethylene glycol (PEG) linker.

### References

Chee et al., “Evaluation of anionic and non-ionic surfactant performance for Montney shale gas hydraulic fracturing fluids”, Journal of Petroleum Exploration and Production (2021), 11:1973-1991.

Muherei et al., “Equilibrium Adsorption Isotherms of Anionic, Nonionic Surfactants and Their Mixtures to Shale and Sandstone”, Modern Applied Science (2009), 3 (2): 158-167.

1. Use of concentrated ammonium hydroxide or other weak base as an etching agent for the release of a tracer encapsulated in a silica outer shell.

2. The use of claim 1, wherein the other weak base is an organic weak base, a biodegradable weak base, a volatile weak base, or any combination thereof.

3. The use of claim 1 or 2, wherein the tracer is or comprises an anionic tracer, a cationic tracer, a zwitterionic tracer, a charge-neutral tracer, a biological tracer (e.g., peptide, protein, lipid, nucleic acid, or polysaccharide), a polynucleotide tracer (e.g., DNA, RNA, or polynucleotide analog), a chemical tracer (e.g., a halogenated benzoic ester), a radioactive tracer, a dye tracer, a polymeric tracer, or any combination thereof.

4. The use of any one of claims 1 to 3, wherein the tracer is complexed with a nanoparticle to form a tracer-nanoparticle core, which is encapsulated in the silica outer shell.

5. The use of claim 4, wherein the tracer is complexed to the nanoparticle ionically, covalently, or via physisorption.

6. The use of claim 4 or 5, wherein the nanoparticle comprises or consists of a silica nanoparticle (SNP), a magnetic nanoparticle, a gold nanoparticle, a silver nanoparticle, metal-oxide nanoparticle, a carbon-based nanoparticle, a ceramic nanoparticle, a metal nanoparticle, semiconductor nanoparticles, a polymeric nanoparticle, a lipid-based nanoparticle, or any combination thereof.

7. The use of any one of claims 4 to 6, wherein the nanoparticle, or the tracer-nanoparticle core encapsulated in the silica outer shell, has an average minimum diameter of at least 1, 25, 50, 75, 100, 125,150, 175, 200, 250, 300, 350, 400, 450, or 500 nm, and/or an average maximum diameter of 100, 125,150, 175, 200, 250, 300, 350, 400, 450, 500, 550, 600, 650, 700, 750, 800, 850, 950, 1000, 2000, 2500,3000, 4000, 5000, 6000, 7000, 8000, 9000, or 10,000 nm.

8. The use of any one of claims 1 to 7, wherein the tracer is released by contacting the silica outer shell with an etching solution comprising said etching agent: for at least 3, 3.5, 4, 4.5, 5, 5.5, 6, 7, 8, 9, 10,11, 12, 24, 36, 48, 60, or 72 hours: and/or at a temperature of at least 45, 50, 55, 60, 65, or 70° C.

9. The use of any one of claims 1 to 8, wherein the tracer is released without the use of hydrofluoric acid or other highly corrosive acid.

10. The use of any one of claims 1 to 9, wherein the encapsulated tracer is from a fracture fluid sample.

11. A method for recovering a tracer encapsulated in a silica outer shell, said method comprising:
(a) contacting the silica outer shell with an etching solution comprising ammonium hydroxide or other weak base as an etching agent at a sufficient concentration and for a sufficient time to enable release of the tracer into solution: and
(b) isolating and/or detecting the released tracer.

12. The method of claim 11, wherein the silica outer shell is contacted with the etching solution: for at least 3, 3.5, 4, 4.5, 5, 6, 7, 8, 9, 10, 11, 12, 24, 36, 48, 60, or 72 hours; and/or at a temperature of at least 45, 50, 55, 60, 65, or 70° C.

13. The method of claim 11 or 12, wherein:
(a) the other weak base is as defined in claim 2:
(b) the tracer is as defined in any one of claims 3 to 7: or
(c) both (a) and (b).

14. The method of any one of claims 11 to 13, wherein the tracer encapsulated in the silica outer shell is from a fluid sample, such as a fracture fluid sample.

15. The method of any one of claims 11 to 14, wherein the etching of the silica outer shell is carried out without the use of hydrofluoric acid or other highly corrosive acid.

16. The method of any one of claims 11 to 15, wherein the tracer is detected via a lateral flow or other suitable rapid point-of-use test.

17. The method of any one of claims 11 to 16, wherein the tracer is a polynucleotide or polynucleotide analog capable of Watson-Crick base pairing, and the detecting comprises amplification (e.g., PCR), hybridization, sequencing, CRISPR-based detection, or any combination thereof.

18. A method of tracing fluids in subsurface formations (e.g., fracturing fluids in oil-or gas-containing subsurface formations), the method comprising:
(a) providing a plurality of unique encapsulated tracers, each tracer encapsulated in a silica outer shell:
(b) pumping a plurality of fracturing fluid volumes into the subsurface formation, each volume comprising a unique encapsulated tracer, thereby defining a plurality of fracture zones;
(c) pumping fluids out of the formation while taking well fluid samples:
(d) collecting the unique encapsulated tracers from each well fluid sample and releasing the unique encapsulated tracers by contacting the silica outer shell with an etching solution comprising ammonium hydroxide or other weak base as an etching agent at a sufficient concentration and for a sufficient time to enable release of the tracer into solution; and
(e) identifying and/or detecting the unique tracer within each well fluid sample.

19. The method of claim 18, wherein:
(i) the tracer is as defined in any one of claims 3 to 7;
(ii) the other weak base is as defined in claim 2;
(iii) the etching in (d) is performed as defined in any one of claim 8, 9, 11 or 12;
(iv) the subsurface formations comprise predominantly anionic rock material (e.g., shale or sandstone); or
(v) any combination of (i) to (iv).

20. A method of encapsulating a tracer prone to adsorption on a rock material (e.g., shale or sandstone), the method comprising:
(a) providing a silica nanoparticle (SNP) that is functionalized to facilitate complexing to the tracer prone to adsorption on the rock material:
(b) complexing the tracer to the silica nanoparticle in the presence of a buffer that facilitates tracer loading or deposition on the SNP to form a tracer-nanoparticle core: and
(c) encapsulating the tracer-nanoparticle core in a silica shell by treating the tracer-nanoparticle core particles with a silica shell-forming solution in the presence of a low concentration of ammonium hydroxide for a sufficient time to fully encapsulate the tracer-nanoparticle core, optimally said low concentration of ammonium hydroxide being 0.01 to 0.2 M, 0.015 to 0.15 M, 0.02 to 0.1 M, 0.025 to 0.075 M: or being at about 0.01, 0.02, 0.03, 0.04, 0.05, 0.06,0.07, 0.08, 0.09, 0.1, 0.125, 0.15, or 0.175 M.

21. The method of claim 20, wherein the silica shell-forming solution comprises trimethyl [3-(trimethoxysilyl) propyl] ammonium chloride (TMAPS) and tetraethoxysilane (TEOS).

22. The method of claim 20 or 21, wherein the tracer-nanoparticle core in (c) is treated with the silica shell-forming solution for at least 12, 24, 36, 48, 72, or 96 hours.

23. The method of any one of claims 20 to 22, wherein the SNP is functionalized to be cationic, the tracer is an anionic tracer, and the loading or deposition in (b) is performed in the presence of an alkaline buffer (e.g., at a pH of about 7.2, 7.3, 7.4, 7.5, 7.6, 7.7, 7.8, 7.9, 8.0, 8.1, 8.2, 8.3, 8.4, 8.5, 8.6, 8.7, 8.8,

8. 9, or 9; or between 7.2 and 9).

24. The method of any one of claims 20 to 23, wherein the tracer or the tracer-nanoparticle core is as defined in any one of claims 3 to 7.

25. An encapsulated tracer produced by the method of any one of claims 20 to 24, suitable for use in tracing fracturing fluid in oil-or gas-containing subsurface formations (e.g., characterized by predominantly anionic rock material, such as shale or sandstone).

26. A method of tracing a fluid recovered from a subsurface reservoir, the method comprising:
providing the encapsulated tracer as defined above/herein comprising an outer shell and a tracer compound, in a formation to mix with a reservoir fluid:
recovering a portion of the reservoir fluid to surface, the reservoir fluid comprising the encapsulated tracer; and
detecting the tracer compound in the sample.

27. The method of claim 26, wherein the encapsulated tracer is injected into the formation via a well or deployed in a downhole tool for release upon contact with flow of the reservoir fluid.

28. The method of claim 26 or 27, wherein the reservoir fluid comprises an aqueous fluid, a hydrocarbon based fluid, a water-hydrocarbon emulsion, or a geothermal fluid.

29. The method of any one of claims 26 to 28, wherein the detecting of the tracer compound in the sample comprises: de-encapsulating the encapsulated tracer in the sample to cause release of the tracer compound from the outer shell; and measuring a concentration of the released tracer compound.

30. The method of claim 29, wherein the de-encapsulating comprises etching.

31. The method of any one of claims 26 to 30, wherein the method is performed in a multistage fracturing process using unique tracer compounds for respective fracturing stages.

32. The method of any one of claims 26 to 30, wherein the method is performed in a hydrocarbon recovery process using unique tracers for respective zones along a well to monitor well injectivity, well productivity, or properties of the reservoir fluid at the respective zones.

33. The method of any one of claims 26 to 32, wherein:
(i) the tracer compound is the tracer as defined in any one of claims 3 to 7;
(ii) the other weak base is as defined in claim 2;
(iii) detecting the tracer compound in the sample comprises etching the outer shell as defined in claim 8, 9, 11, or 12;
(iv) the subsurface reservoir comprises predominantly anionic rock material (e.g., shale or sandstone); or
(v) any combination of (i) to (iv).
